(19) United States
(12) Patent Application Publication
(10) Pub. No.: US 2006/0213452 A1
(43) Pub. Date: Sep. 28, 2006

(54) PET CARRIER

(76) Inventor: Lise King, Port Washington, NY (US)

Correspondence Address: WILLIAM COLLARD;COLLARD & ROE, P.C., 1077 NORTHERN BOULEVARD, ROSLYN, NY, 11576, US

(21) Appl. No.: 11/277,082

(22) Filed: Mar. 21, 2006

Related U.S. Application Data
(60) Provisional application No. 60/665,790, filed on Mar. 28, 2005.

(51) Int. Cl. A01K 1/03

(52) U.S. Cl. 119/496

(57) ABSTRACT

A device for transporting animals has an enclosure with a collapsible frame. There can also be a covering coupled to the enclosure. The enclosure has at least four side walls, a top, and a bottom with at least three of said side walls having a portal. There can also be a plurality of straps coupled to the enclosure. In addition, there can also be a plurality of compartments formed in the enclosure. The plurality of compartments include at least a first compartment and at least a second compartment. There can also be at least one door formed in the first compartment of the enclosure. There can also be at least one door formed in the second compartment of the enclosure.

### CROSS REFERENCE TO RELATED APPLICATIONS

Applicant claims priority under 35 U.S.C. §119(e) of Provisional Application No. 60/665,790 filed on Mar. 28, 2005, the disclosure of which is hereby incorporated herein by reference.

### BACKGROUND OF THE INVENTION

The invention relates to a device for transporting animals comprising an enclosure with a collapsible frame. With this design, a pet or other animal can be safely transported in a portable collapsible enclosure which also creates a safe and comfortable enclosure for a pet.

### SUMMARY OF THE INVENTION

The invention relates to a device for transporting animals comprising an enclosure with a collapsible frame. There can also be a covering coupled to the enclosure. The enclosure has at least four side walls, a top, and a bottom with at least three of the side walls having a portal. There can also be a plurality of straps coupled to the enclosure. In addition, there can also be a plurality of compartments formed in the enclosure. There can also be at least one door formed in the first compartment of the enclosure. There can also be at least one door formed in one of the compartments of the enclosure.

All of the features disclosed above may be optional. For example, there can be at least one platform, disposed inside of the second compartment.

In addition, another optional feature is that the covering is in the form of a mesh screen covering the frame of the enclosure.

In this case, the frame can be in the form of a plurality of metal rods which can be coupled together to form the frame.

There can also be an optional padding for covering the frame of the enclosure. This padding can be used to protect any animal stored inside of this enclosure.

There can also be an optional padding for forming a bottom surface of the first compartment in this enclosure. This padding can be used to provide a comfortable platform for a pet disposed inside of this enclosure.

There can also be an optional divider for dividing the enclosure into a plurality of compartments.

Another optional feature is that each portal can be in the form of a window, that is selectively openable. The window can be in the form of a round window that can be opened via a zipper forming a circumference around the window.

The window can also include an optional additional padding disposed around at least an inside region of the window.

Another optional feature is that at least one of the doors formed in the first compartment in the enclosure can be in the form of a top opening in the enclosure. This door can be in the form of a zipper opening in the top of the covering.

Straps which can be attached to this enclosure can be used to transport the enclosure, with at least one of the straps being used to secure the enclosure to a car seat or to a portion of a car during transport.

Thus, with this design, a pet or other animal can be safely transported in a portable collapsible enclosure which also creates a safe and comfortable enclosure for a pet.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of an embodiment of the device according to the invention;

FIG. 2 is a first side view of the device of FIG. 1;

FIG. 3 is a second side view of the device of FIG. 1;

FIG. 4 is another side view of the device of FIG. 1;

FIG. 5A is another side view of the device of FIG. 1;

FIG. 5B is a perspective view of the divider;

FIG. 5C is a perspective view of the platform;

FIG. 6 is a top view of the device;

FIG. 7 is a bottom view of the device;

FIG. 8 is a perspective view of another embodiment of the device; and

FIG. 9 is another view of the second embodiment of the device.

### DETAILED DESCRIPTION OF PREFERRED EMBODIMENTS

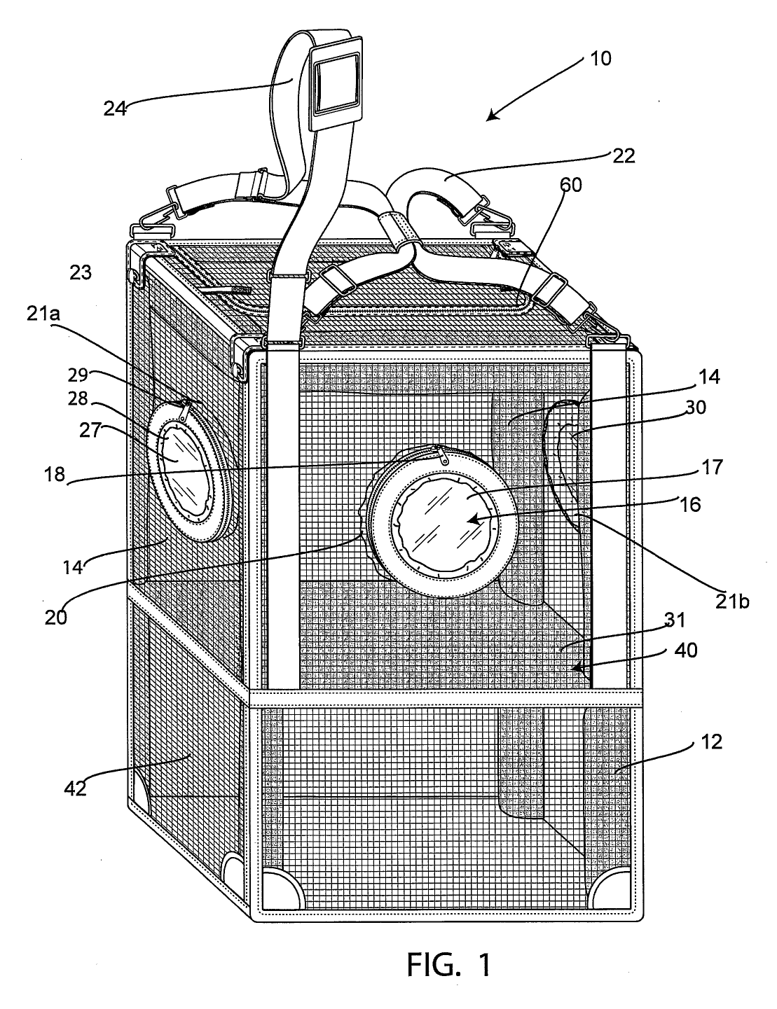

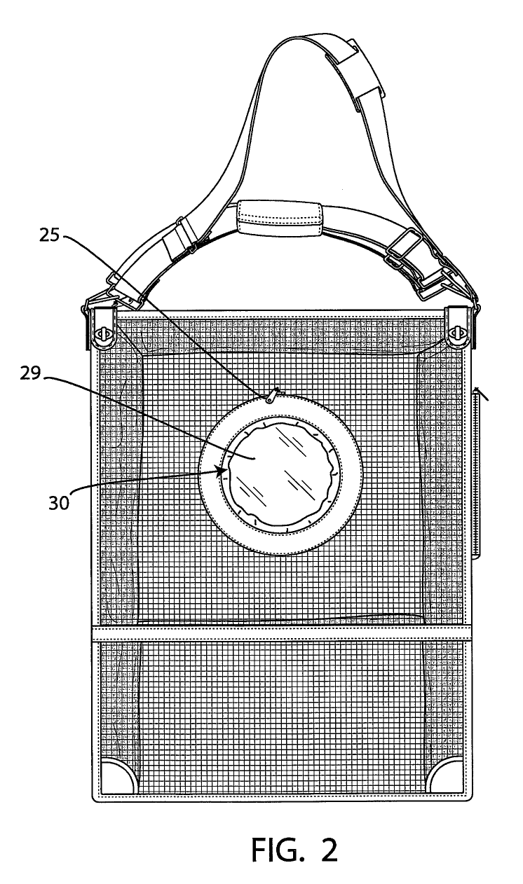

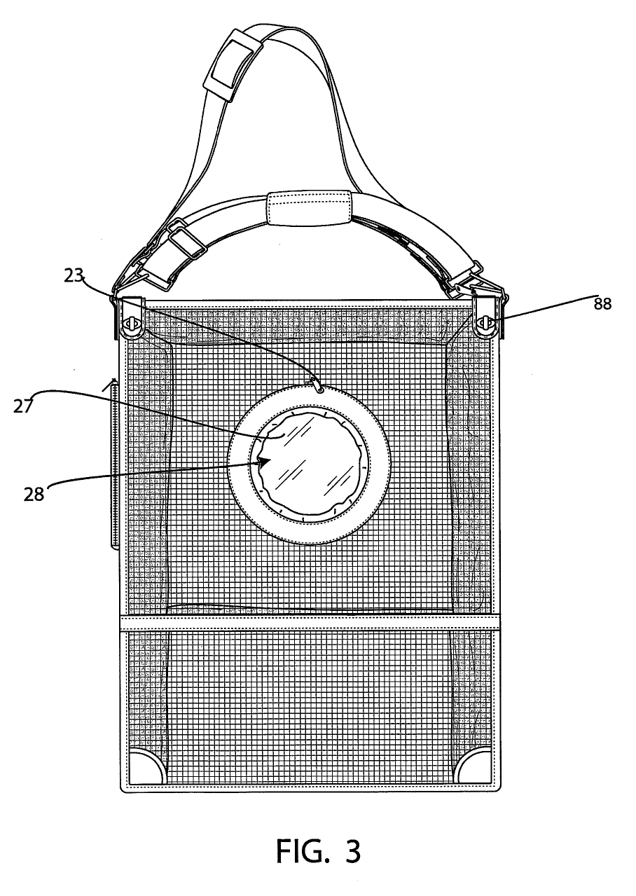

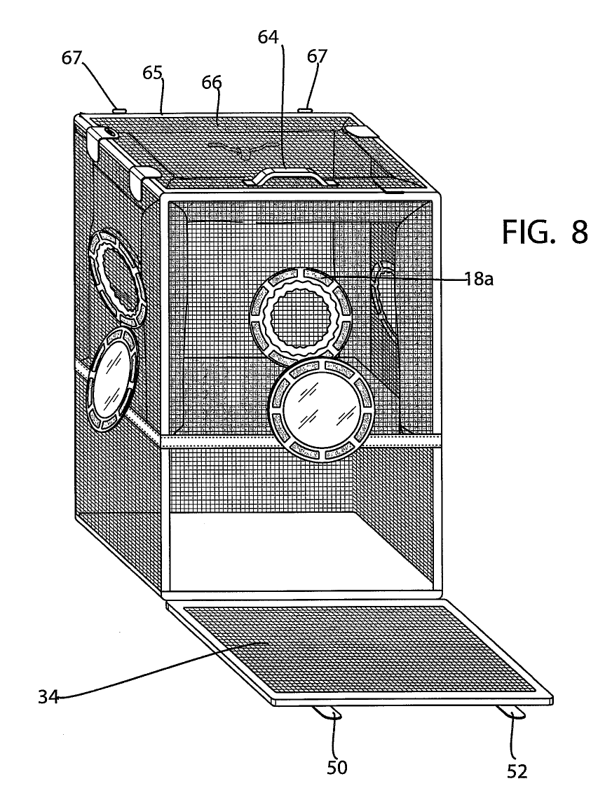

Referring in detail to the drawings, FIG. 1 shows a perspective view of a device 10 in partially unassembled form. Device 10 can be in the form of an animal enclosure which can include a frame 12 covered or surrounded by a covering 14. Covering 14 can be in the form of a mesh screen or fishnet covering. This enclosure can include at least four sides, a top and a bottom. In one optional feature, there can be three portals or windows disposed on three of the sides. For example, there can be a first window 16 which can include a window covering 17 and at least one fastener 18 surrounding the outside of the window. This fastener can be in the form of velcro 18a (See FIG. 8) or zipper enclosures 18, which can be used to secure window covering 17 over window 16. This window can also include a padding 20 which provides additional padding so that when an animal sticks or extends its head outside of the window, the padding protects the animal's neck and head from injury. There can also be additional windows 28 and 30 disposed on alternative sides of this enclosure (See FIGS. 2 and 3.) These additional windows 28 and 30 also include substantially similar or the same characteristics as first window 16, including coverings 27 and 29, fasteners 23 and 25, and padding 21a and 21b.

There can also be a plurality of straps, such as a first set of straps 22, a second set of straps 24, and a third set of straps 26 (See FIG. 4). First set of straps or handle 22 can be used to assist the user in picking up this device. In addition, another strap, or carrying strap 24 can be used to allow the user to place this device over the user's shoulder so that this device can be carried more easily. This strap can be known as a carrying strap. The third set of straps 26 can be attached to a back face of the enclosure wherein this first strap can be used to secure the device to a car or any other device. This third set of straps (See FIG. 4) can include straps 26a and 26b, which can be interlocked with a seat belt to secure the device to a seat.

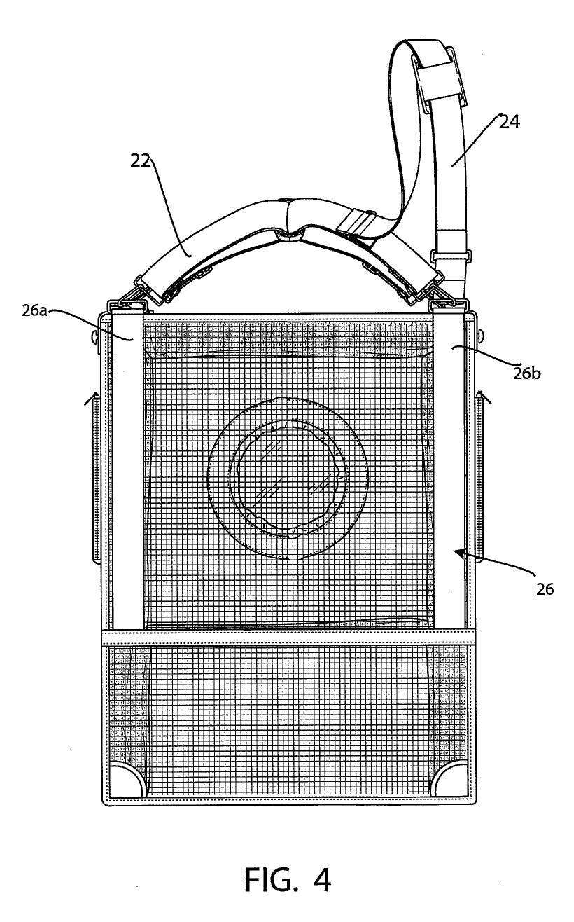

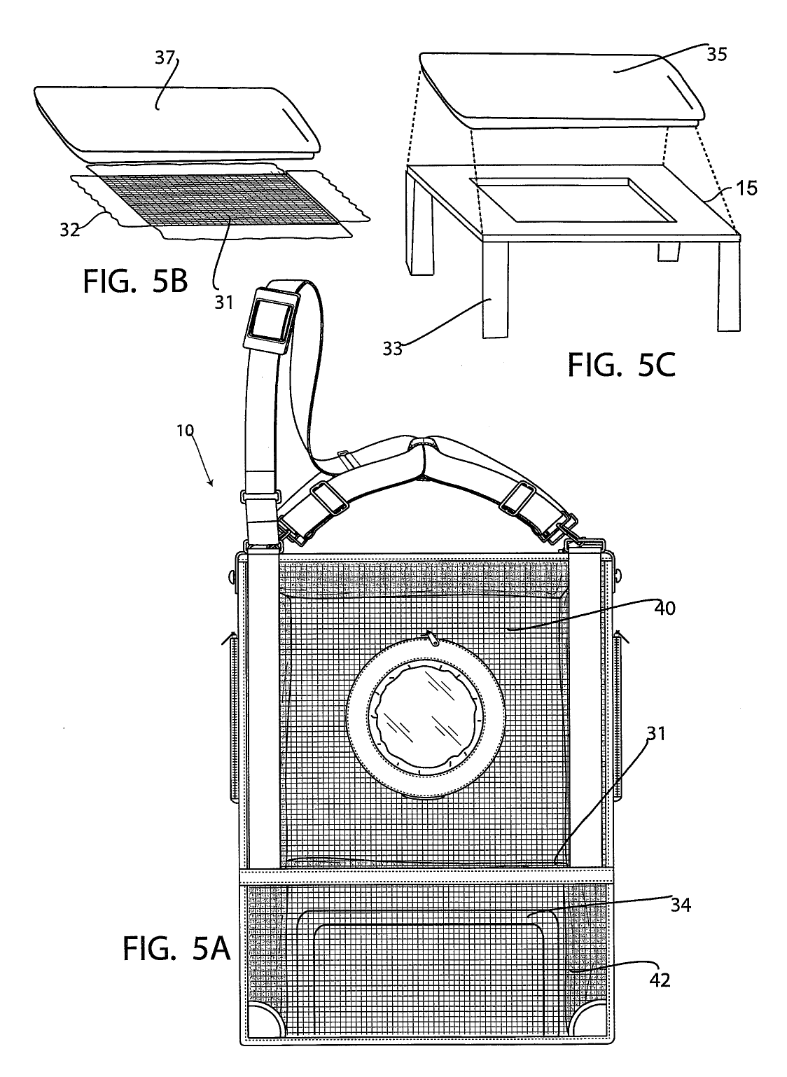

FIG. 5A shows a front view of the embodiment having a divider 31 (See FIG. 5B) which can be in the form of a mesh screen having attaching elements 32 which can be used to attach to adjacent portions of frame 12 and covering 14 to form a divider 31 which divides first compartment 40 from a second compartment 42. There can also be a platform 33 (See FIG. 5C) which can be disposed in second compartment 42. Platform 33 can be inserted through a door 34 which opens up to second compartment 42. Platform 33 can include a padding or a padded section 35 to provide bottom support padding for an animal. There could also be an optional alternative padding 37 which can be disposed on top of divider. In an alternative embodiment, as shown in FIG. 8, door 34 can also include a frame section and a mesh screen and also includes clasps 50 and 52 which can be used to close and lock the door together.

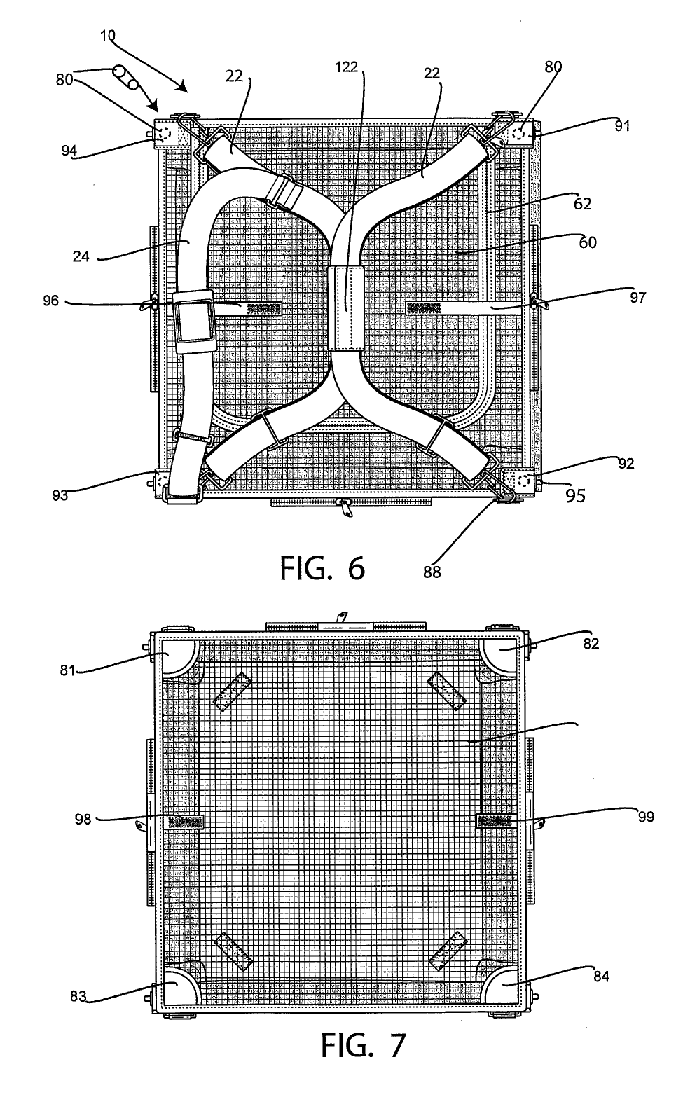

FIG. 6 shows a top door 60 that can be in the form of a flexible mesh screen which is attached to the remaining portion of cover 14 via a zipper connection 62, or alternatively a top door 64 (FIG. 8) which can be in the form of a frame section 65 and a mesh section 66. Zipper connection 62 can extend around a peripheral portion of three sides of top door 60 so that a user can unzip three sides and open up top door 60 as a flap. Alternatively, as shown in FIG. 8, if door 60 is formed as a solid frame having the mesh screen on top, door 61 can be coupled to the remaining portion of the frame via a hinge 67.

The top view in FIG. 6 shows straps 22 interlocking in a strap interlocking element 122 which locks straps 22 together. This view also shows strap 24, which attaches to straps 22 at one end and to a corner of the device at an opposite end. These straps can connect to the body of the enclosure via a clasp 88, which locks to a loop on the enclosure. There are also locking straps 96 and 97 which can be used to lock or close a top section of the enclosure to a bottom section. In this case, rods 80 are removed, along with platform 33, and then the top of the enclosure is pressed down to the bottom of the enclosure so that straps 96 and 97 attach to connection elements 98 and 99. This creates a securely closed enclosure.

Rods 80 can be inserted into a flap which can be coupled to each corner of the covering. When these rods 80 are inserted, it can be used to vertically expand the device, with locking flaps 91, 92, 93, 94 extending over an opening in each of the flaps inside of the covering to selectively lock each of these rods inside. Locking flaps 91, 92, 93, 94 can include a clasp 95 for the securing of this device.

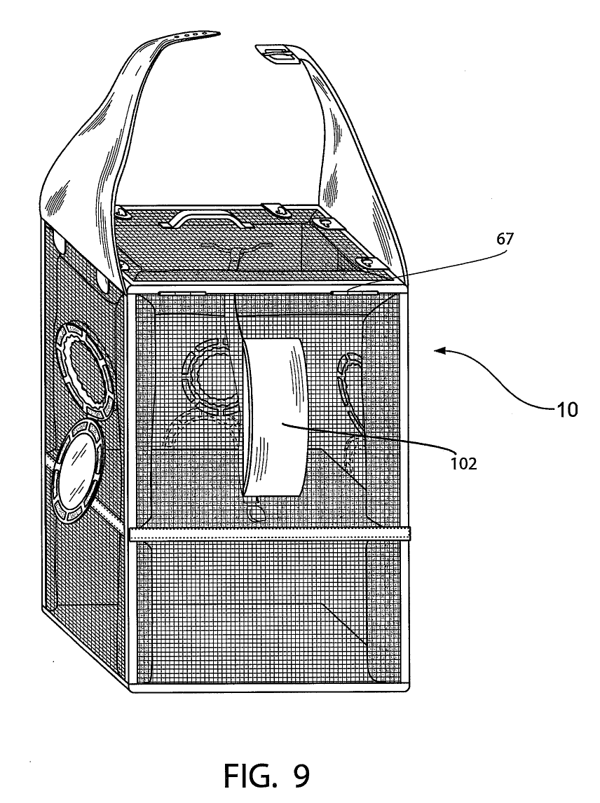

FIG. 9 shows an alternative embodiment of the device which shows a back strap 102 coupled to covering 14. This back strap can be used to secure the device to a seat via a seat belt.

The design of this device can thus be used to easily transport an animal inside of a compartment where the animal is positioned in this compartment with portals extending on at least one side, allowing the animal to extend its head outside of the enclosure. This enclosure is collapsible and easily transportable for any user wishing to use this enclosure.

Accordingly, while a few embodiments of the present invention have been shown and described, it is to be understood that many changes and modifications may be made thereunto without departing from the spirit and scope of the invention as defined in the appended claims.

What is claimed is:

1. A device for transporting animals comprising:
a) an enclosure comprising:
i) a collapsible frame; and
ii) a covering coupled to said frame, wherein said enclosure has at least four side walls, a top and a bottom with at least three of said side walls each having a portal;
b) a plurality of straps coupled to said enclosure;
c) a plurality of compartments formed in said enclosure, wherein said plurality of compartments include at least one first compartment and at least one second compartment;
d) at least one door formed in said first compartment of said enclosure; and
e) at least one door formed in said second compartment of said enclosure.

2. The device as in claim 1, further comprising at least one platform, disposed inside of said at least one second compartment.

3. The device as in claim 1, wherein said covering is in the form of a mesh screen covering said frame of said enclosure.

4. The device as in claim 1, wherein said frame is in the form of a plurality of metal rods which can be coupled to said covering to form said frame.

5. The device as in claim 1, further comprising a padding for covering said frame of said enclosure.

6. The device as in claim 1, further comprising a padding for forming a bottom surface of said first compartment in said enclosure.

7. The device as in claim 1, further comprising a divider for dividing said enclosure into said plurality of compartments.

8. The device as in claim 1, wherein at least one portal in said first compartment is in the form of a window, that is selectively openable.

9. The device as in claim 8, wherein said window is in the form of a round window that can be opened via a zipper surrounding said window.

10. The device as in claim 9, further comprising additional padding disposed around at least an inside region of said window.

11. The device as in claim 1, wherein said door formed in said first compartment in said enclosure, is in the form of a top opening in said enclosure.

12. The device as in claim 11, wherein said door is in the form of a zipper opening in said top of said enclosure.

13. A device for transporting animals comprising:
a) an enclosure comprising:
i) a collapsible frame;
ii) a covering coupled to said frame, wherein said enclosure has at least four side walls, a top and a bottom with at least one of said side walls having a portal;
b) a plurality of straps coupled to said enclosure;
c) a plurality of compartments formed in said enclosure, wherein said plurality of compartments include at least one first compartment and at least one second compartment;
d) at least one door formed in said first compartment of said enclosure; and
e) at least one door formed in said second compartment of said enclosure.

14. The device as in claim 13, further comprising at least one additional portal disposed on another one of the side walls.

15. A device for transporting animals comprising:
a) an enclosure comprising:
i) a collapsible frame;
ii) a covering coupled to said frame, wherein said enclosure has at least three portals;
b) a plurality of straps coupled to said enclosure, wherein said plurality of straps include at least one carrying strap and at least one securing strap adapted to receive a seat belt for securing the enclosure to a car seat;
c) a plurality of compartments formed in said enclosure, wherein said plurality of compartments include at least one first compartment and at least one second compartment;
d) at least one door formed in said first compartment of said enclosure; and
e) at least one door formed in said second compartment of said enclosure.
